(19) United States
(12) Patent Application Publication
(10) Pub. No.: US 2020/0023236 A1
(43) Pub. Date: Jan. 23, 2020

(54) MYODYNAMIC MEASUREMENT SYSTEM AND MYODYNAMIC MEASUREMENT DEVICE THEREOF

(71) Applicant: Tao-Yuan General Hospital, Ministry of Health and Welfare, Taoyuan City (TW)

(72) Inventors: Chia-Hong CHEN, New Taipei City (TW); Hsueh-Hsien CHANG, Taoyuan City (TW)

(21) Appl. No.: 16/151,956

(22) Filed: Oct. 4, 2018

(30) Foreign Application Priority Data
Jul. 20, 2018 (TW) 107125161

(51) Int. Cl. A63B 24/00; G01D 5/40; A63B 21/22

(52) U.S. Cl. CPC A63B 24/0062; A63B 21/22; G01D 5/40

(57) ABSTRACT

A myodynamic measurement system is provided in the present invention. The myodynamic measurement system comprises a myodynamic measurement device and a controller. The myodynamic measurement device comprises a main body, a motor, a clutch, a rope, a handle, an accelerometer, and a displacement detector. The main body has an allocation space and a through hole. The motor is disposed in the allocation space. The clutch is disposed in the allocation space and engaged with the motor. The rope is engaged with the clutch and is extended from the through hole. The handle is fixed on the rope. The accelerometer is utilized for detecting acceleration change of the handle. The displacement detector is utilized for detecting a moving distance of the rope. The controller comprises a communication module and a control module. The control module is utilized for controlling the motor to provide a pulling force and controlling the clutch to engage with the motor and the rope through the communication module.

This application claims the benefit of Taiwan Patent Application Serial No. 107125161, filed on Jul. 20, 2018, the subject matter of which is incorporated herein by reference.

### BACKGROUND OF INVENTION

### 1. Field of the Invention

The present invention is related to a myodynamic measurement system and a myodynamic measurement device, and more particularly is related to the myodynamic measurement system and the myodynamic measurement device calculating the muscular force value by using the pulling force, the rope displacement, and the acceleration detecting value.

### 2. Description of the Prior Art

In general, myodynamic measurement is helpful for athletes or fitness lovers to understand his own physical status or to determine the training outcome. Besides, myodynamic measurement can also be used as an indicator of rehabilitation progress for those in need.

As mentioned, the conventional myodynamic measurement device is nothing more than a force gauge such as a grip strength meter or a pull meter, which applies Hook's Law to measure the deformation of the spring within its elastic limit and calculates the stretching force or the compression force based on the deformation and the modulus of elasticity. Because these devices measure the myodynamic force based on the elasticity of the spring, the types of measurable myodynamic forces are quite limited.

### SUMMARY OF THE INVENTION

Because the conventional myodynamic measurement device measures the muscular force value of a tester mainly based on the elastic force and the deformation of the spring. Under the restriction of the size of the spring structure itself, only a constant elastic force can be provided. The elastic force cannot be adjusted to meet the need of different testers, and the starting position to apply the force cannot be adjusted with respectively to different muscular parts to be tested. Accordingly, it is an object of the present invention to provide a myodynamic measurement system and a myodynamic measurement device, which are capable of providing various types of myodynamic measurement by controlling the pulling force, such as the measurement of maximum muscular force, functional muscular force, muscular endurance, and muscular power of different parts of user's body under concentric contraction or eccentric contraction.

In accordance with the aforementioned object, a myodynamic measurement system is provided in the present invention. The myodynamic measurement system comprises a myodynamic measurement device and a controller. The myodynamic measurement device comprises a main body, a motor, a clutch, a rope, a handle, and a displacement detector. The main body has an allocation space and a through hole extending to the allocation space. The motor is disposed in the allocation space. The clutch is disposed in the allocation space and engaged with the motor. The rope is engaged with the clutch and is extended from the through hole to outside the main body. The handle is fixed on the rope. The displacement detector is disposed on the main body for detecting a moving distance of the rope to generate a rope displacement value.

The controller comprises a communication module and a control module. The communication module is communicated with the motor, the clutch, and the displacement detector. The control module is electrically connected to the communication module, for controlling the motor to provide a pulling force and controlling the clutch to engage with the motor and the rope through the communication module, and for calculating a muscular force value based on a rope tension, the rope displacement value, and a response time.

In accordance with an embodiment of the present invention, the myodynamic measurement device further comprises a rope length restricting element for keeping a length of the rope outside the main body.

In accordance with an embodiment of the present invention, the displacement detector is an infra-red displacement detector or an encoder.

In accordance with an embodiment of the present invention, the myodynamic measurement device further comprises a buzzer, which is communicated with the controller, and the control module controls the buzzer to generate an alarm when the rope displacement value detected of the rope displacement signal reaches a predetermined length.

In accordance with an embodiment of the present invention, the myodynamic measurement device further comprises an accelerometer, which is disposed on the handle and communicated with the communication module and is utilized for detecting acceleration change of the handle along a moving direction to generate an acceleration detecting value.

In accordance with an embodiment of the present invention, the clutch comprises an unmovable plate, a driven part, and a clutch controller. The unmovable plate is fixed to an output shaft of the motor. The driven part comprises a bearing seat, a driven shaft, and a movable plate. The bearing seat is disposed in the allocation space. The driven shaft is rotatably disposed on the bearing seat, and the rope is fixed to the driven shaft. The movable plate is fixed to the driven shaft for selectively engaging with the unmovable plate. The clutch controller is disposed in the allocation space and connected to the driven shaft for controlling engagement between the movable plate and the unmovable plate through the driven shaft.

As mentioned above, because the myodynamic measurement system and the myodynamic measure device thereof provided in the present invention include the motor for setting the pulling force and the clutch for adjusting the starting position of the handle, the myodynamic measurement system and the myodynamic measurement device thereof are capable of measuring maximum muscular force, functional muscular force, muscular endurance, or muscular power of various body parts of different users under concentric contraction or eccentric contraction.

### BRIEF DESCRIPTION OF THE DRAWINGS

The present invention will now be specified with reference to its preferred embodiment illustrated in the drawings, in which:

FIG. 1 is a perspective view of a myodynamic measurement system provided in accordance with a preferred embodiment of the present invention;

FIG. 2 is a planar schematic view of a myodynamic measurement system provided in accordance with a preferred embodiment of the present invention;

FIG. 3 is a block diagram showing a myodynamic measurement system provided in accordance with a preferred embodiment of the present invention;

FIG. 4 is a planar schematic view showing the condition in which the movable plate and the unmovable plate are separate and the tester keeps the handle at the starting position;

FIG. 5 is a planar schematic view showing the tester standby condition in which the clutch controller pushes the driven shaft to have the movable plate engaging with the unmovable plate and tenses the rope by using the motor;

FIG. 6 is a planar schematic view showing the condition in which the motor drives the driven shaft so as to pull the rope, the handle, as well as the hands of the tester toward the main body;

FIG. 7 is a planar schematic view showing the condition in which the movable plate and the unmovable plate are separate, the rope length restricting element is clamped on the rope, and the tester keeps the handle at the starting position;

FIG. 8 is a planar schematic view showing the tester standby condition in which the clutch controller pushes the driven shaft to have the movable plate engaging with the unmovable plate and the rope length restricting element is clamped on the rope; and

FIG. 9 is a planar schematic view showing the condition in which the tester resists the pulling force from the motor to pull the handle upward.

### DESCRIPTION OF THE PREFERRED EMBODIMENT

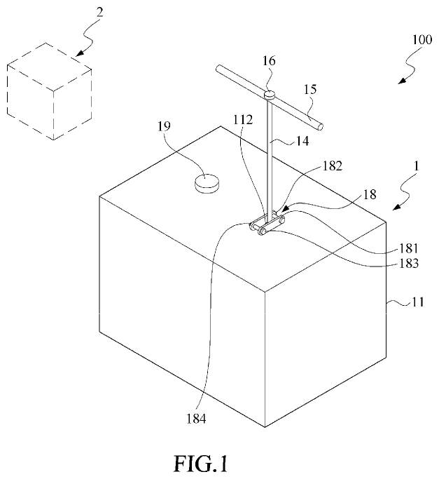

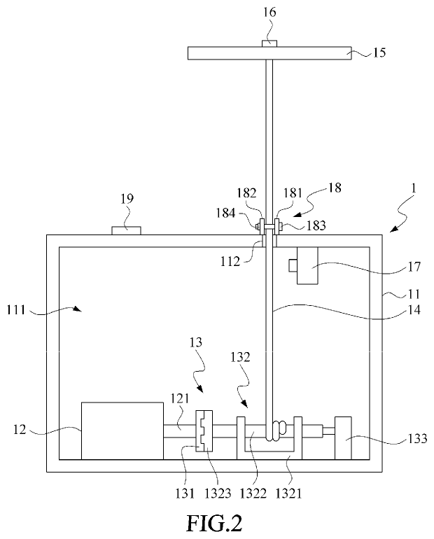

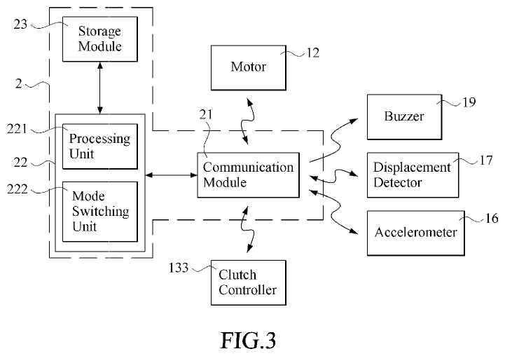

Please refer to FIGS. 1 to 3, wherein FIG. 1 is a perspective view of a myodynamic measurement system provided in accordance with a preferred embodiment of the present invention, FIG. 2 is a planar schematic view of a myodynamic measurement system provided in accordance with a preferred embodiment of the present invention, and FIG. 3 is a block diagram showing a myodynamic measurement system provided in accordance with a preferred embodiment of the present invention. As shown, the myodynamic measurement system 100 includes a myodynamic measurement device 1 and a controller 2.

The myodynamic measurement device 1 includes a main body 11, a motor 12, a clutch 13, a rope 14, a handle 15, an accelerometer 16, a displacement detector 17, a rope length restricting element 18, and a buzzer 19.

The main body 11 has an allocation space 111 and a through hole 112 extending to the allocation space 111. The motor 12 is disposed in the allocation space 111. The clutch 13 is disposed in the allocation space 111 and includes an unmovable plate 131, a driven part 132, and a clutch controller 133. The unmovable plate 131 is fixed to an output shaft 121 of the motor 12. The driven part 132 includes a bearing seat 1321, a driven shaft 1322, and a movable plate 1323. The bearing seat 1321 is disposed in the allocation space 111, the driven shaft 1322 is rotatably disposed on the bearing seat 1321, and the rope 14 is fixed to the driven shaft 1322. The movable plate 1323 is fixed to the driven shaft 1322 for selectively engaging with the unmovable plate 131. The clutch controller 133 is disposed in the allocation space 111 and is connected to the driven shaft 1322 for controlling the engagement between the movable plate 1323 and the unmovable plate 131 by controlling the movement of the driven shaft 1322 so as to have the clutch 13 selectively engaging with the motor 12.

The rope 14 is engaged with the driven shaft 1322 and is extended from the through hole 112 to outside the main body 11. The handle 15 is fixed on the rope 14. The accelerometer 16 is disposed on the handle 15 for detecting acceleration change of the handle 15 to generate an acceleration detecting value along the moving direction. The displacement detector 17 is disposed on the main body 11 for detecting a moving distance of the rope 14 to generate a rope displacement value. In the present embodiment, the displacement detector 17 is an infra-red displacement detector, however, in the other embodiments, the displacement detector 17 can be an encoder, which is disposed on an output shaft 121 of the motor 12 for calculating the moving distance of the rope 14 based on the rotation angle of the output shaft 121 to generate the rope displacement value.

The rope length restricting element 18 is utilized for keeping the length of the rope 14 outside the main body 11. In the present embodiment, the rope length restricting element 18 has a first fixing plate 181 and a second fixing plate 182 oppositely disposed at two sides of the rope 14, two bolts 183 (only one of them is labelled in the figure) passing through the first fixing plate 181 and the second fixing plate 182 respectively to constraint the rope 14 among the first fixing plate 181, the second fixing plate 182, and the two bolts 183, and two nuts 184 (only one of them is labelled in the figure) in conjunction with the bolts 183 such that if the length of the rope 14 should be kept, the bolts 183 and the nuts 184 could be used to fasten the first fixing plate 181 and the second fixing plate 182 so as to firmly clamp the rope 14 and keep the length of the rope 14. The buzzer 19 is disposed on the main body 11 for generating an alarm.

The controller 2 includes a communication module 21, a control module 22, and a storage module 23. The communication module 21 is communicated with the motor 12, the clutch 13, the accelerometer 16, the displacement detector 17, and the buzzer 19. The control module 22 is electrically connected to the communication module 21 and includes a processing unit 221 and a mode switching unit 222. The processing unit 221 is utilized for controlling the motor 12 to provide a pulling force and controlling the clutch 13 to engage with the motor 12 and the rope 14 through the communication module 21, and for calculating a muscular force value based on the pulling force, the rope displacement value, and the acceleration detecting value.

The mode switching unit 222 is provided for the tester 200 or a helper to switch the measuring modes. In the present embodiment, the mode switching unit 222 can do the switching among a maximum concentric muscular force measuring mode, a maximum eccentric muscular force measuring mode, a muscular endurance measuring mode, a functional muscular force measuring mode, and a muscular power measuring mode. In addition, the control module 22 is also capable to control the buzzer 19 to generate an alarm when the rope displacement value detected based on the rope displacement signal reaches a predetermined length. The storage module 23 is electrically connected to the control module 22 for storing the muscular force value calculated by the control module 22.

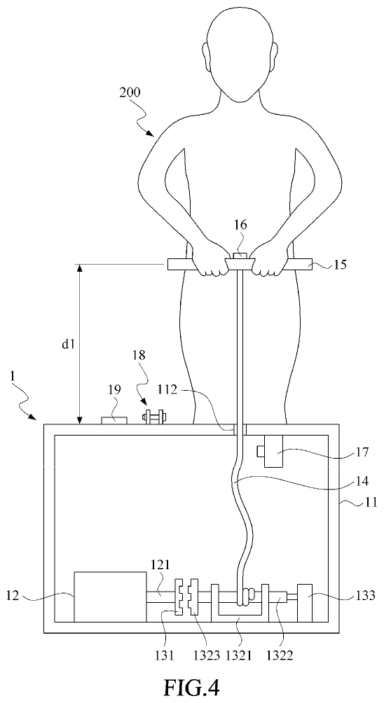

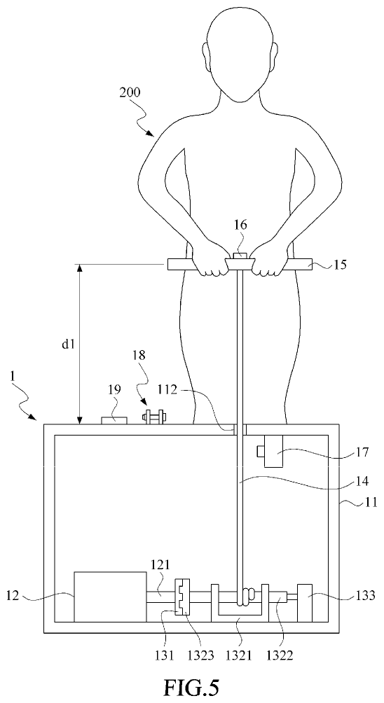

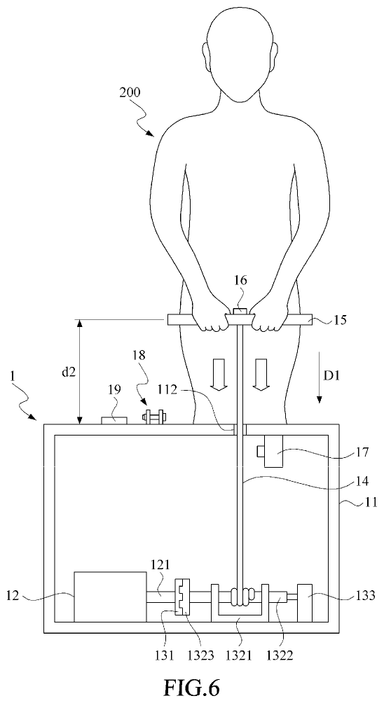

Please refer to FIGS. 3 to 6, wherein FIG. 4 is a planar schematic view showing the condition in which the movable plate and the unmovable plate are separate and the tester keeps the handle at the starting position, FIG. 5 is a planar schematic view showing the tester standby condition in which the clutch controller pushes the driven shaft to have the movable plate engaging with the unmovable plate, and tenses the rope by using the motor, and FIG. 6 is a planar schematic view showing the condition in which the motor drives the driven shaft so as to pull the rope, the handle, as well as the hands of the tester toward the main body.

As shown in FIG. 4, if a tester 200 wants to measure a maximum eccentric muscular force value, firstly, the mode switching unit 222 of the control module 22 is used to select the maximum eccentric muscular force measuring mode. At this time, the tester 200 would hold the handle 15 and adjust the handle 15 to the starting position in correspondence to the height and the muscular status of the tester 200 to have the length of the rope 14 extending outside the through hole 112 kept at a first length d1. When adjusting the starting position of the handle 15, the clutch controller 133 can be used to separate the movable plate 1323 and the unmovable plate 131 to prevent the driven shaft 1322 from being held by the motor 12 so as to make sure that the driven shaft 1322 is rotatable.

Then, the control module 22 may control the buzzer 19 to start the sound of countdown in the preparing time to notify the tester 200 that the control module 22 may control the clutch controller 133 to have the unmovable plate 131 engaging with the movable plate 1323 first and control the motor 12 to rotate the driven shaft 1322 till the rope 14 is straightened (as shown in FIG. 5) after the handle 15 has been adjusted to the starting position in the preparing time. In practice, the motor 12 may be set to stop the rotation when a resistance force (the force applied by the tester 200 holding the handle 15) is detected so as to straighten the rope 14.

Thereafter, after the rope 14 has been straightened, the buzzer 19 rings as the preparing time is ended, and the control module 22 controls the motor 12 to provide an increasing torque as the pulling force. In the present embodiment, the increasing torque is gradually increased from 0 kg to 20 kg. Then, as the tester 200 cannot withstand the increasing torque provided by the motor 12 to keep the handle 15 at the starting position, the handle 15 may be pulled along a first direction D1 to have the length of the rope 14 extending outside the through hole 112 kept at a second length d2 (as shown in FIG. 6). The displacement detector 17 would record the displacement change of the rope 14 (d1−d2), and the control module 22 would record the instant torque value provided by the motor 12 when the displacement change of the rope 14 recorded by the displacement detector 17 reaches a predetermined change value and regard the instant torque value provided by the motor 12 as the maximum eccentric muscular force value to be stored in the storage module 23. In the present embodiment, as the predetermined change value is set to be 10 cm, if the torque value provided by the motor 12 when the rope 14 is pulled down 10 cm (the displacement change) is 15 kg, the maximum eccentric muscular force value of the tester 200 would be regarded as 15 kg.

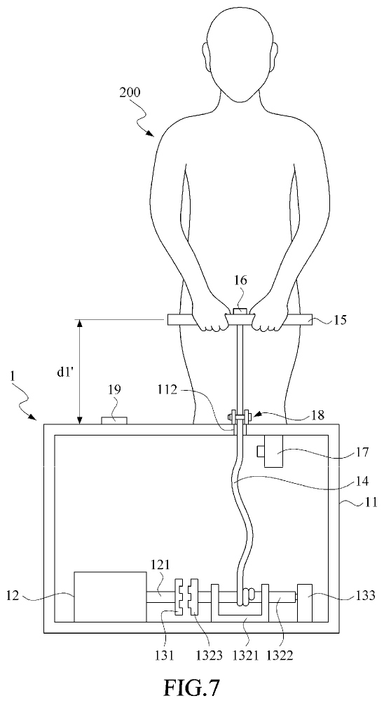

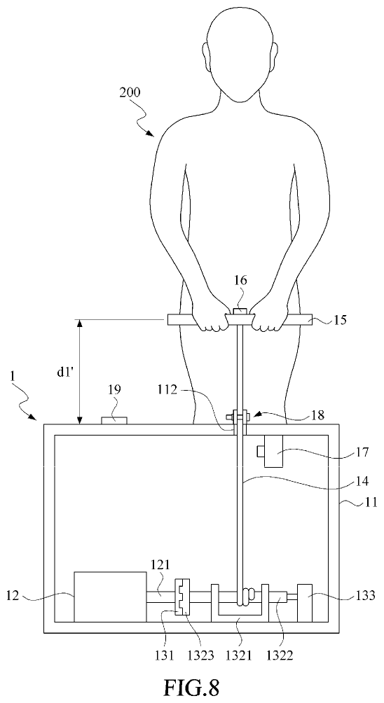

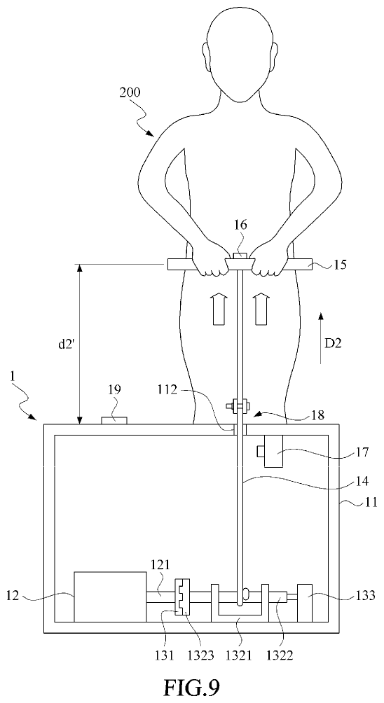

Please refer to FIGS. 3, 7, 8, and 9, wherein FIG. 7 is a planar schematic view showing the condition in which the movable plate and the unmovable plate are separate, the rope length restricting element is clamped on the rope, and the tester keeps the handle at the starting position, FIG. 8 is a planar schematic view showing the tester standby condition in which the clutch controller pushes the driven shaft to have the movable plate engaging with the unmovable plate and the rope length restricting element is clamped on the rope, and FIG. 9 is a planar schematic view showing the condition in which the tester resists the pulling force from the motor to pull the handle upward. As shown in FIG. 7, if a tester 200 wants to measure a maximum concentric muscular force value, the tester 200 would hold the handle 15 and adjust the handle 15 to the starting position in correspondence to the height or the pose of the tester 200 (as shown in FIG. 7) to have the length of the rope 14 extending outside the through hole 112 kept at a first length d1′. Then, the rope length restricting element 18 is used to clamp the rope 14 near the through hole 112.

Thereafter, the mode switching unit 222 of the control module 22 is used to select the maximum concentric muscular force measuring mode. At this time, the control module 22 may control the buzzer 19 to start the sound of countdown in the preparing time to notify the tester 200 to hold the handle 15 as soon as possible, and then the control module 22 may control the clutch controller 133 to have the movable plate 1323 engaging with unmovable plate 131 by moving the driven shaft 1322 (as shown in FIG. 8).

Afterward, the buzzer 19 rings as the preparing time is ended, and the control module 22 controls the motor 12 to provide a decreasing torque. The countdown ended alarm provided by the buzzer 19 is controlled by the control module 22 and is utilized to notify the tester 200 to pull the handle 15 upward. In the present embodiment, the decreasing torque is set to gradually decrease from 20 kg to 0 kg. Thus, when the tester 200 pulls the handle 15 along a second direction D2 under the decreasing torque provided by the motor 12 to have the length of the rope 14 extending outside the through hole 112 reaches a second length d2′, the control module 22 may record the instant torque value provided by the motor 12 when the displacement change of the rope 14 (d2′−d1′) recorded by the displacement detector 17 reaches a predetermined change value, and regard the torque value as the maximum concentric muscular force value stored in the storage module 23. In the present embodiment, as the predetermined change value is set to be 10 cm, if the torque value provided by the motor 12 when the rope 14 is pulled up 10 cm (d2′−d1′) is 15 kg, the maximum concentric muscular force value of the tester 200 would be regarded as 15 kg.

It should be mentioned that, the main purpose of using the rope length restricting element 18 to keep the length of the rope 14 is to prevent the high starting torque from pulling the rope 14 inside the main body 11 and also to prevent the tester 200 holding the handle 15 from withstanding too much pulling force to cause damages.

Please refer to FIGS. 3, 7, 8, and 9, as shown, if the tester 200 wants to measure the functional muscular force value, firstly, the mode switching unit 222 of the control module 22 is used to select the functional muscular force measuring mode, similar to that for the maximum concentric muscular force measuring mode. At this time, the tester 200 would hold the handle 15 and adjust the handle 15 to the starting position in correspondence to a specific action, and use the rope length restricting element 18 to clamp the rope 14 near the through hole 112 (as shown in FIG. 7) so as to have the length of the rope 14 extending outside the through hole 112 kept at a first length d1′. In the present embodiment, the specific action is the action of lifting a heavy load from a lower position to a higher position.

Then, the control module 22 may control the buzzer 19 to start the sound of countdown in the preparing time. After the tester 200 has adjusted to the handle 15 to the starting position in the preparing time, the control module 22 may control the clutch controller 133 to have the unmovable plate 131 engaging with the movable plate 1323 (as shown in FIG. 8), and the control module 22 may also control the motor 12 to provide a constant torque. The constant torque can be the commonly used torque such as 5 kg or 10 kg to simulate the weight of the load for the tester 200 to do the functional muscular force test with respective to different constant torques. In the present embodiment, the constant torque is 5 kg. As the countdown is ended and the buzzer 19 rings, the tester 200 pulls the handle 15 upward (as shown in FIG. 9), and then, when the displacement detector 17 detects that the tester 200 pulls the handle 15 upward to have the length of the rope 14 extending outside the through hole 112 reaches a predetermined second length d2′, the buzzer 19 generates a sound again. The control module 22 records the acceleration value transmitted by the accelerometer 16 disposed on the handle 15 and the working time, figures out the functional muscular force value of the tester 200 lifting 5 kg weight by using the acceleration value, the working time, and the constant torque, and stores the functional muscular force value and the working time in the storage module 23. In the present embodiment, as the predetermined change value (d2′−d1′) is set to be 100 cm, if the torque value provided by the motor 12 when the rope 14 is pulled upward 100 cm is 15 kg and the working time is 10 seconds, the functional muscular force working time would be 10 seconds when the concentric muscular force value of the tester 200 is 5 kg.

Please refer to FIGS. 3, 7, 8, and 9, as shown in FIG. 7, if the tester 200 wants to measure the muscular endurance value, firstly, the mode switching unit 222 of the control module 22 is used to select the muscular endurance measuring mode, similar to that for the maximum concentric muscular force measuring mode. At this time, the tester 200 would hold the handle 15 and adjust the handle 15 to the starting position for doing the muscular endurance test, and use the rope length restricting element 18 to clamp the rope 14 near the through hole 112 so as to have the length of the rope 14 extending outside the through hole 112 kept at the first length. In the present embodiment, the muscular endurance test needs the tester 200 to pull the handle 15 repeatedly within a specific stretching range, and the starting position for the muscular endurance test is the starting point of the stretching range.

Then, the control module 22 may control the buzzer 19 to start the sound of countdown in the preparing time. After the tester 200 has adjusted to the handle 15 to the starting position in the preparing time, the control module 22 may control the motor 12 to provide a constant torque. In the present embodiment, the constant torque is 5 kg. The unmovable plate 131 and the movable plate 1323 are engaged as shown in FIG. 8. As the countdown is ended and the buzzer 19 rings, the tester 200 pulls the handle 15 upward (as shown in FIG. 9), and then, when the displacement detector 17 detects that the tester 200 pulls the handle 15 to have the length of the rope 14 extending outside the through hole 112 reaches a second length to have the handle 15 reaches the end point of the stretching range, i.e. the rope displacement value detected based on the rope displacement signal transmitted by the displacement detector 17 reaches a predetermined length, the control module 22 may control the buzzer 19 to generate the sound again, and the control module 22 would record the velocity value transmitted by the accelerometer 16 disposed on the handle 15 and the working time. The tester 200 releases the handle 15 after hearing the alarm to have the handle 15 driven by the motor 12 back to the starting position. Then, the tester 200 holds the handle 15 and pulls the handle 15 to the end point of the stretching range again, and the control module 22 controls the buzzer 19 to generate the sound and records the velocity value of the stretching and the working time once more. The aforementioned process is repeated until multiple data are recorded. The average velocity value of the second half of these data divided by the average velocity value of the whole data is regarded as the endurance indicator. For example, if the number of recorded data is 30, the average value of the last 15 records is divided by the average value of the whole 30 records as the endurance indicator.

Please refer to FIGS. 3 to 6, as shown, when the tester 200 wants to measure the muscular power value, similar to the maximum eccentric muscular force measuring mode, the mode switching unit 222 of the control module 22 is used to select the muscular power measuring mode. At this time, the tester 200 would hold the handle 15 and adjust the handle 15 to the starting position (as shown in FIG. 4) in correspondence to the height and muscular status of the tester 200 to have the length of the rope 14 extending outside the through hole 112 kept at the first length d1. Then, the buzzer 19 starts to countdown. As the tester 200 adjusts the handle 15 to the starting position within the preparing time, the control module 22 uses the clutch controller 133 to control the engagement (as shown in FIG. 5). The buzzer 19 rings as the countdown is ended, and the control module 22 controls the motor 12 to provide a constant torque. In the present embodiment, the constant torque is 5 kg. As the constant torque is provided by the motor 12, the hands of the tester 200 together with the handle 15 would be pulled toward the main body 11 (as shown in FIG. 6). The accelerometer 16 is used to measure the time and acceleration value needed for the tester 200 to pull the handle 15 back to the starting position as the indicator of muscular power value after the tester 200 notifies that the handle 15 moves and does the reaction.

In conclusion, the conventional myodynamic measurement device measures the muscular force value of the tester by using the elastic force of the spring. Under the restriction of the constant elastic force, the elastic force cannot be adjusted to meet the need of different users, and the starting position for applying force cannot be adjusted as well. In contrast, because the myodynamic measurement system and the myodynamic measure device thereof provided in the present invention use the motor to provide the pulling force. The motor can be controlled to adjust or change the pulling force. In addition, the present invention also has the clutch for the tester to adjust the starting position of the handle, the myodynamic measurement system and the myodynamic measurement device thereof are capable to be adjusted in correspondence with the height of the tester, the muscular part to be tested, the muscular status, and the various holding poses to facilitate the usage. In addition, because of the rope length restricting element, the length of the rope can be kept constant to have the tester holding the handle starts the muscular testing with a pulling force applied thereto such that the maximum concentric muscular force value, the functional muscular force value, the muscular endurance value, and etc. can be measured. Moreover, because of the accelerometer disposed in the myodynamic measurement device, the muscular power value can be measured. Thus, the present invention does make the usage of the myodynamic measurement device more convenient effectively.

While the present invention has been particularly shown and described with reference to a preferred embodiment, it will be understood by those skilled in the art that various changes in form and detail may be without departing from the spirit and scope of the present invention.

What is claimed is:

1. A myodynamic measurement system, comprising:
a myodynamic measurement device, comprising:
a main body, having an allocation space and a through hole extending to the allocation space;
a motor, disposed in the allocation space;
a clutch, disposed in the allocation space, and engaged with the motor;
a rope, engaged with the clutch, and extended from the through hole to outside the main body;
a handle, fixed on the rope; and
a displacement detector, disposed on the main body, for detecting a moving distance of the rope to generate a rope displacement value; and
a controller, comprising:
a communication module, communicated with the motor, the clutch, and the displacement detector; and
a control module, electrically connected to the communication module, for controlling the motor to provide a pulling force through the communication module and controlling the clutch to engage with the motor and the rope.

2. The myodynamic measurement system of claim 1, wherein the myodynamic measurement device further comprises a rope length restricting element, for restricting a length of the rope outside the main body.

3. The myodynamic measurement system of claim 1, wherein the displacement detector is an infra-red displacement detector or an encoder.

4. The myodynamic measurement system of claim 1, wherein the myodynamic measurement device further comprises a buzzer, which is communicated with the controller, and the control module controls the buzzer to generate an alarm when the rope displacement value detected by the displacement detector reaches a predetermined length.

5. The myodynamic measurement system of claim 1, wherein the myodynamic measurement device further comprises an accelerometer, disposed on the handle and communicated with the communication module, utilized for detecting acceleration change of the handle to generate an acceleration detecting value or a working time, and transmitting the acceleration detecting value to the control module through the communication module.

6. A myodynamic measurement device, comprising:
a main body, having an allocation space and a through hole extending to the allocation space;
a motor, disposed in the allocation space;
a clutch, disposed in the allocation space, and engaged with the motor;
a rope, engaged with the clutch, and extended from the through hole to outside the main body;
a handle, fixed on the rope; and
a displacement detector, disposed on the main body, for detecting a moving distance of the rope to generate a rope displacement value.

7. The myodynamic measurement device of claim 6, further comprising a rope length restricting element, for keeping a length of the rope outside the main body.

8. The myodynamic measurement device of claim 6, further comprising a buzzer for generating an alarm.

9. The myodynamic measurement device of claim 6, wherein the clutch comprises:
an unmovable plate, fixed to an output shaft of the motor;
a driven part, comprising:
a bearing seat, disposed in the allocation space;
a driven shaft, rotatably disposed on the bearing seat, and the rope being fixed to the driven shaft;
a movable plate, fixed to the driven shaft, for selectively engaging with the unmovable plate; and
a clutch controller, disposed in the allocation space and connected to the driven shaft, for controlling engagement between the movable plate and the unmovable plate through the driven shaft.
